(19) United States
(12) Patent Application Publication
(10) Pub. No.: US 2015/0094157 A1
(43) Pub. Date: Apr. 2, 2015

(54) ROTATIONAL CONNECTOR DEVICE

(71) Applicant: KENNETH A. LOCK, WESTMINSTER, CA (US)

(72) Inventor: KENNETH A. LOCK, WESTMINSTER, CA (US)

(21) Appl. No.: 14/209,716

(22) Filed: Mar. 13, 2014

Related U.S. Application Data
(63) Continuation-in-part of application No. 13/998,067, filed on Sep. 27, 2013.

(51) Int. Cl. F16D 3/221

(52) U.S. Cl. CPC F16D 3/221
USPC 464/141; 464/147

(57) ABSTRACT

A rotational connector device is disclosed which incorporates a housing that is attached to a first shaft and an inner member that is disposed within the housing and connected to a second shaft. The first and second shaft may be at skewed angles with respect to each other. The housing and the inner member are slidably and rotationally connected to each other by way of a washer and pin to provide one-to-one rotational motion between the first and second shafts.

### CROSS-REFERENCE TO RELATED APPLICATIONS

This is a continuation-in-part application of U.S. application Ser. No. 13/998,067, filed Sep. 27, 2013, the contents of which are expressly incorporated herein by reference.

### STATEMENT RE: FEDERALLY SPONSORED RESEARCH/DEVELOPMENT

Not Applicable

### BACKGROUND

The various aspects and embodiments disclosed herein relate to a joint for providing rotational motion between two members (e.g., shafts) at a skewed angle, namely, shafts which are not axially aligned with respect to each other.

In many mechanical systems, two shafts which are not coaxially aligned to each other may be required to transmit rotational motion from a first shaft to a second shaft. These mechanical systems may utilize a joint to transfer rotational motion between the first and second shafts. Unfortunately, the first and second shafts may not rotate at the same angular rotational speed. Due to the angle, the driven shaft may speed up and slow down during rotation. When multiple shafts are joined to each other in series, the inability of the first and second shaft to rotate at the same speed throughout its entire 360° rotation may cause the joints to bind and increases the work needed to rotate the shafts. Likewise problematic is the fact that such prior art systems are incapable of accepting axial loads, in particular thrust and pulling forces due to inferior design.

Accordingly, there is a need in the art for an improved joint for transmitting constant rotational motion between two shafts disposed at a skewed angle.

### BRIEF SUMMARY

The various embodiments disclosed herein address the needs discussed above, discussed below and those that are known in the art.

A rotational connector device is disclosed which permits one to one rotation between a first member and a second member even if the first and second members are at a skewed angle. The first member may be connected to a housing of the device, whereas the second member may be connected to an inner member disposed within the housing. During rotation of the first and second members, the housing and the inner member are slidably and rotationally attached to each other. In particular, the housing has a notch in which a washer (or bearing) is disposed. The inner member has a protrusion (e.g., pin) that engages the washer. During rotation of the first and second members, the washer rotates up and down in the notch. The protrusion rotates within a recess of the washer. In this manner, the device is a continuous velocity device that allows one to one rotation between the first and second members during rotation.

In one aspect, a device for providing constant rate rotational motion between first and second rotating members is disclosed. The first and second rotating members may be skewed or axially unaligned with respect to each other. The device may comprise a housing, an inner member and a first pin. The housing may have a central cavity therein with a first slot formed in an interior sidewall of the housing. The housing may be attached to the first rotating member. The inner member may be attached to the second rotating member. The inner member may be rotatably disposed within the central cavity of the housing. The first pin may be attached to the inner member and protrude out from an exterior surface of the inner member. The first pin may be slidably disposed within the first slot as the first and second members rotate.

The central cavity of the housing may be spherical and the exterior surface of the inner member may also be spherical so that the inner member is rotatably disposed within the central cavity during rotation of the first and second rotating members.

The device may also have a second slot formed in the interior sidewall of the housing and a second pin attached to the inner member protruding out from the exterior surface of the inner member. The second pin may be slidably disposed within the second slot as the first and second members rotate.

The device may also comprise first and second bearings (e.g., first and second washers). The first bearing may have a first recess for receiving the first pin wherein the first bearing may be slideably disposed within the first slot. The second bearing may have a second recess for receiving the second pin wherein the second bearing may be slideably disposed within the second slot. The first and second pins rotate within the first and second recesses as the first and second members rotate.

The first and second slots may be disposed 180 degrees from each other with respect to a center of the central cavity. The first and second pins may be disposed 180 degrees from each other with respect to a center of the inner member. The center of the central cavity and the center of the inner member may be aligned to each other (i.e., intersect each other) so that the first and second pins are aligned to and are slideably disposed within the first and second slots during rotation of the first and second rotating members.

The housing may comprise first and second halves wherein an interior surface of the first and second halves define the central cavity. The junction between the first and second halves intersect at an equator of a spherical central cavity.

The device may further comprise two or more slots formed in the housing and two or more pins attached to the inner member wherein the pins are slidably disposed within the slots.

The pins may have a cylindrical configuration.

The device may further comprise a first bearing having a first recess for receiving the first pin. The first bearing may be slideably disposed within the first slot.

The device may further comprise a first bearing having a first recess for receiving the first pin and a second bearing having a second recess for receiving the second pin.

The device may further comprise a handle integrated into either one of the first and second rotating members. A tool holder may be integrated into the other one of the first and second rotating members. The tool holder may be configured to receive a socket.

The pin may be rotatably attached to the inner member.

The device may further comprise a threaded hole formed in the housing and a set screw tightenable into the threaded hole to set an initial angle between the first and second rotating members. A distal tip of the set screw may be Teflon coated and may frictionally contact either the inner member or the first or second bearings to maintain the initial angle.

In another aspect, a method for rotating two skewed or axially unaligned first and second rotating members is disclosed. The method may comprise the steps of providing a joint for constant rotational motion between the first and second rotating members; rotating the first rotating member; rotating the housing; sliding the first pin within the first slot; and rotating the second rotating member. The device of the providing step may comprise a housing and an inner member. The housing may have a central cavity therein with a first slot formed in an interior sidewall of the housing. The housing may be attached to the first rotating member. The inner member may be attached to the second rotating member. The inner member may have a first pin extending outwardly from an exterior surface of the inner member. The inner member may be rotatably disposed within the central cavity of the housing. The first pin may be slidably disposed within the first slot as the first and second members rotate.

Advantageously, the devices and methods of the present invention effectively and efficiently allow for the transmission of rotational forces via axially unaligned axes far more so than prior art systems and methods, and further allow for axial loads to be readily accepted without compromising performance.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an exploded perspective view of a first embodiment of a continuous velocity joint;

FIG. 2 is an assembled view of the joint shown in FIG. 1 in a first position during rotation;

FIG. 3 illustrates the joint shown in FIG. 2 in a subsequent second position during rotation;

FIG. 4 illustrates the joint shown in FIG. 2 in a subsequent third position during rotation;

FIG. 5 illustrates the joint shown in FIG. 2 in a subsequent fourth position during rotation;

FIG. 6 is an exploded perspective view of a second embodiment of the continuous velocity joint;

FIG. 7 is an assembled view of the joint shown in FIG. 6 in a first position during rotation;

FIG. 8 illustrates the joint shown in FIG. 7 in a subsequent second position during rotation;

FIG. 9 illustrates the joint shown in FIG. 7 in a subsequent third position during rotation;

FIG. 10 illustrates the joint shown in FIG. 7 in a subsequent fourth position during rotation; and

FIG. 11 illustrates the joint shown in FIG. 7 in a subsequent fifth position during rotation.

### DETAILED DESCRIPTION

The present invention is directed to devices and methods that effectively and efficiently allow for the transmission of rotational forces via axially unaligned axes and further allow for axial loads, such as applied by thrusting, pulling, suspension, and the like, to be readily accepted without interfering with operation of the device. The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

Referring now to the drawings, a rotational connector device 10 is shown. The device 10 is operative to transfer rotational movement from a first shaft 12 to a second shaft 14 or vice versa. The device 10 transfers rotational movement uniformly so that a unit amount of rotation from the first shaft 12 corresponds to a unit amount of rotation in the second shaft 14 even if the first and second shafts 12, 14 are at a skewed angle. By way of example and not limitation, a 1° rotational turn of the first shaft 12 corresponds to a 1° rotational turn of the second shaft 14. The first and second shafts 12, 14 rotate at the same speed throughout the rotation. Accordingly, there is no binding between the first and second shafts 12, 14 during the rotational movement. The second shaft 14 turns at the same speed as the first shaft 12. The first and second shafts 12, 14 may be skewed at an angle 17. By way of example and not limitation, such angle 17 may be greater than 0° up to about 75°, and preferably is between more than 0° and about 45° . The device 10 may transfer rotational movement from the first shaft 12 to the second shaft 14 with a pair of washers (or bearings) 16, 18 that slide within the housing 20 and are rotationally pinned to the inner spherical member 22. The washers 16, 18 help increasing the possible angle between the first and second shafts 12, 14. Additionally, the rotational connector device 10 may hold an axial load. By way of example and not limitation, opposing forces (e.g., weight or pulling forces) may be applied to the first and second shafts 12, 14.

According to one embodiment, the housing 20 has first and second halves 24, 26. The first and second halves 24, 26 have an inner surface 28, 30 that form a portion of a spherical cavity in which the spherical inner member 22 is locked between. More particularly, the spherical inner surface 28 terminates at an inner side 32 of the first half 24 of the housing 20. Similarly, the spherical inner surface 30 of the second half 26 of the housing 20 terminates at an inner side 34 of the second half 26 of the housing 20. This junction between the spherical inner surfaces 28, 30 of the first and second halves 24, 26 define the equator of the spherical cavity that holds the spherical inner member 22. The thickness 36 of the first half 24 and the thickness 38 of the second half 26 may be sufficient to hold the inner spherical member 22 within the inner cavity of the housing 20. In other words, the inner spherical member 22 is sandwiched between the first and second halves 24, 26 so that an axial load may be applied to the first and second shafts 12, 14. The axial load may be in any orientation including but not limited to horizontal and vertical.

The first and second halves 24, 26 may also have notches 40, 42, 44 and 46. The inner surfaces of the notches 40-46 may have a cylindrical configuration about axis 47. The axis 47 is parallel to the inner sides 32, 34 of the first and second halves 24, 26 of the housing 20. Moreover, the axis 47 is transverse to a plane in which the notches 40, 42 and 44, 46 reside. The notches 40-46 retain the washers 16, 18 in place and also allow the washers 16, 18 to rotate about the axis 47 during rotational movement of the first and second shafts 12, 14.

The washers 16, 18 may have outer surfaces that mate with the inner surfaces of the notches 40-46. The outer surfaces of the washers 16, 18 may also define a circle or cylinder. Preferably, the outer surfaces of the washers 16, 18 may be cylindrical to match the cylindrical configuration of the inner surfaces of the notches 40-46. Preferably, the outer surfaces of the washers 16, 18 slide on the inner surfaces of the notches 40-46 and do not rub excessively against the inner surfaces of the notches 40-46 which may cause the transfer of rotation of movement between the first and second shafts 12, 14 to be inefficient.

Although not shown, in certain embodiments it is contemplated that washers 16, 18 may be formed as an integral unit and operative to define a generally C-shaped configuration. In such embodiments, and as opposed to having two opposed washers 16, 18 as shown, washers 16, 18 will be interconnected to one another to form a continuous C-shape leaving an opening through which shaft 14 can interconnectably engage with splined recess 70.

The inner surfaces 48, 50 of the washers 16, 18 may at least partially define a sphere when the rotational connector device 10 is assembled. The inner surfaces 48, 50 mate with the outer surface 52 of the spherical inner member 22. During rotation of the shafts 12, 14, the washers 16, 18 may pivot about pivot axis 54.

The pivot axis 54 may be defined by round pins 56, 58 that extend out laterally from the spherical inner member 22. The pins 56, 58 may be fabricated as a unitary structure to the spherical inner member 22. Alternatively, the pins 56, 58 may be separate from the inner spherical member 22 and reside within the recesses 60, 62 formed in the spherical inner member 22. The pins 56, 58 may also be disposed within corresponding recesses 60, 62 of the first and second washers 16, 18. As a further alternative, the pins 56, 58 may be formed as a unitary structure to the washers 16, 18 and the pins 56, 58 will protrude inward and be received within matching recesses formed in the spherical inner member 22. Accordingly, it will be readily understood and appreciated by those skilled in the art that any of a variety of mechanisms can be utilized as to how first and second washers, 16, 18 will be maintained in axial registry relative to pivot axis 54 and that the same can be accomplished by any of the foregoing mechanisms, as well as any additional mechanism that enables a washer 16, 18 to releasably interconnect with the outer surface 52 of the spherical inner member 22 about pivot axis 54, whether it be through mechanisms formed upon the washers, 16, 18, the spherical inner member 22, or both.

The rotational connector device 10 may also have an O-ring 64 that is positioned between the first and second halves 24, 26 of the housing 20. The O-ring 64 may reside within the grooves formed within the inner sides 32, 34 of the first and second halves 24, 26. The O-rings 64 may serve to retain grease or lubricants in the housing 20 during use.

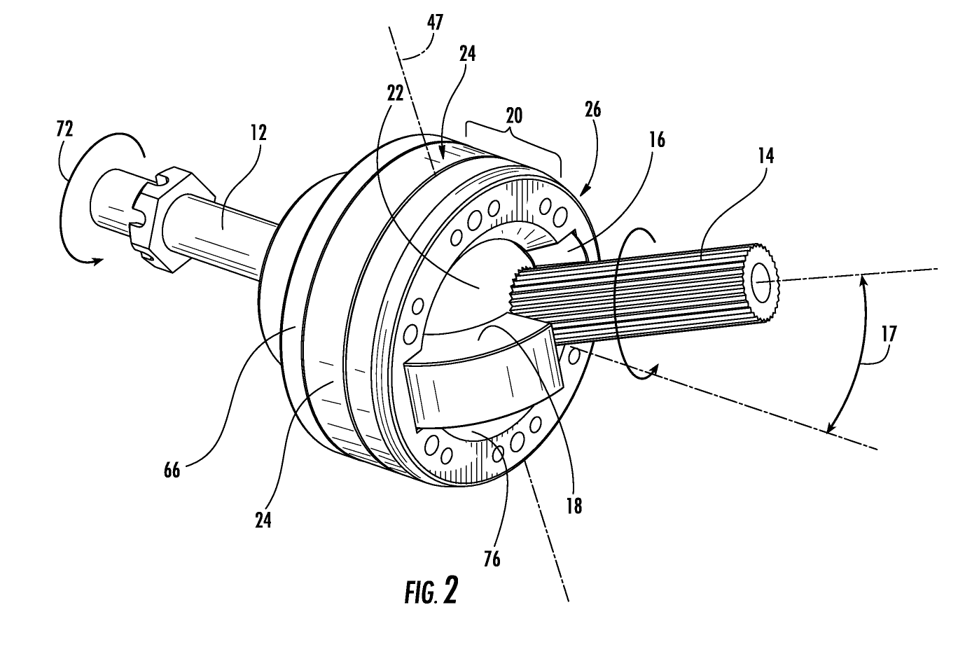

The shafts 12, 14 are respectively secured to the housing 20 and the spherical inner member 22. In particular, one of the shafts 12, 14 is secured to the housing 20. The other one of the shafts 12, 14 is secured to the spherical inner member 22. In FIG. 2, the shaft 12 is shown as being fixedly secured to the housing 20, whereas, the shaft 14 is shown as being fixedly secured to the inner spherical member 22. More particularly, the shaft 12 may be secured to a housing mount 66. The housing mount 66 may be attached to the first half of the housing 20 by any means known in the art or developed in the future. By way of example and not limitation, the housing mount 66 may be bolted or cemented to the first half 24 of the housing 20. Moreover, the first shaft 12 may have a fixed relationship to the housing mount 66. The second shaft 14 may be secured to the inner spherical member 22 so as to have a fixed relationship thereto. The second shaft 14 may be splined and slidably or fixedly engage a splined recessed 70 of the inner member 22.

The lateral side of the second half 26 of the housing 20 may define a conical surface 76. The conical surface 76 allows the angle 17 between the first and second shafts 12, 14 to be increased to a greater degree compared to forming the second half 26 without the conical surface 76. The second shaft 14 rides closely adjacent to the conical surface 76 during rotational movement of the rotational connector device 10 when the angle 17 between the first and second shafts 12, 14 is at its maximum angle.

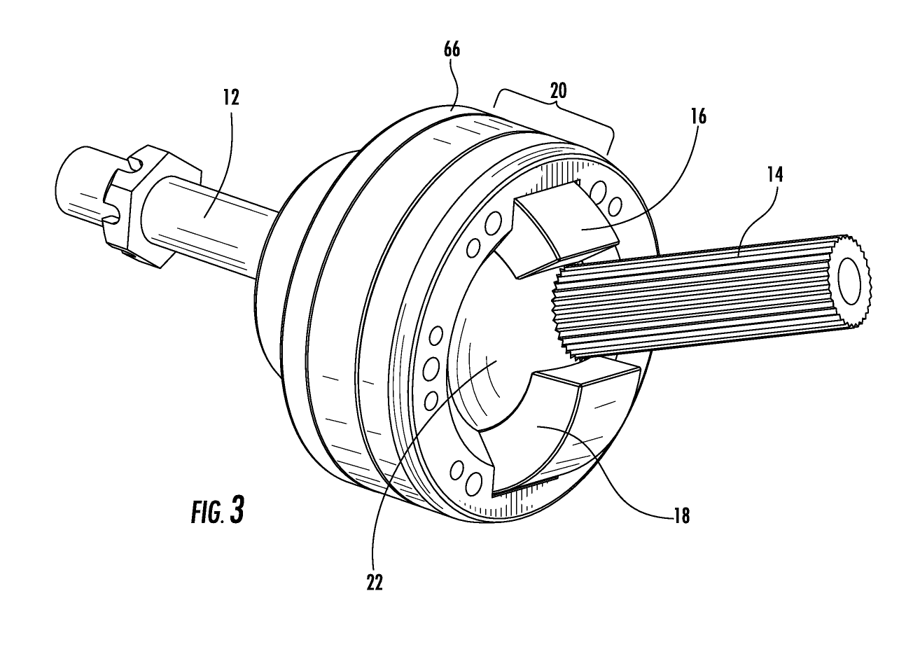

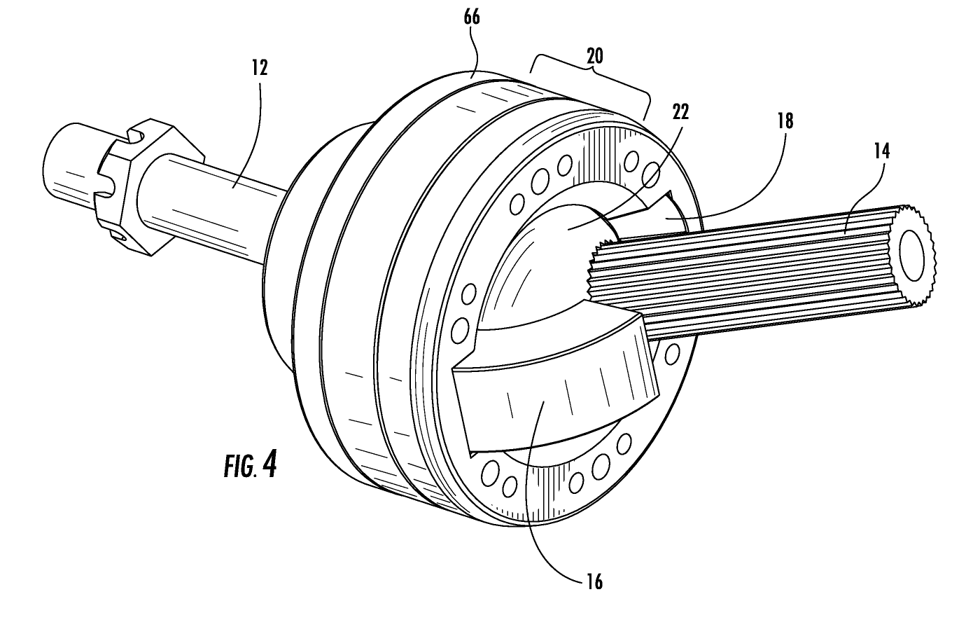

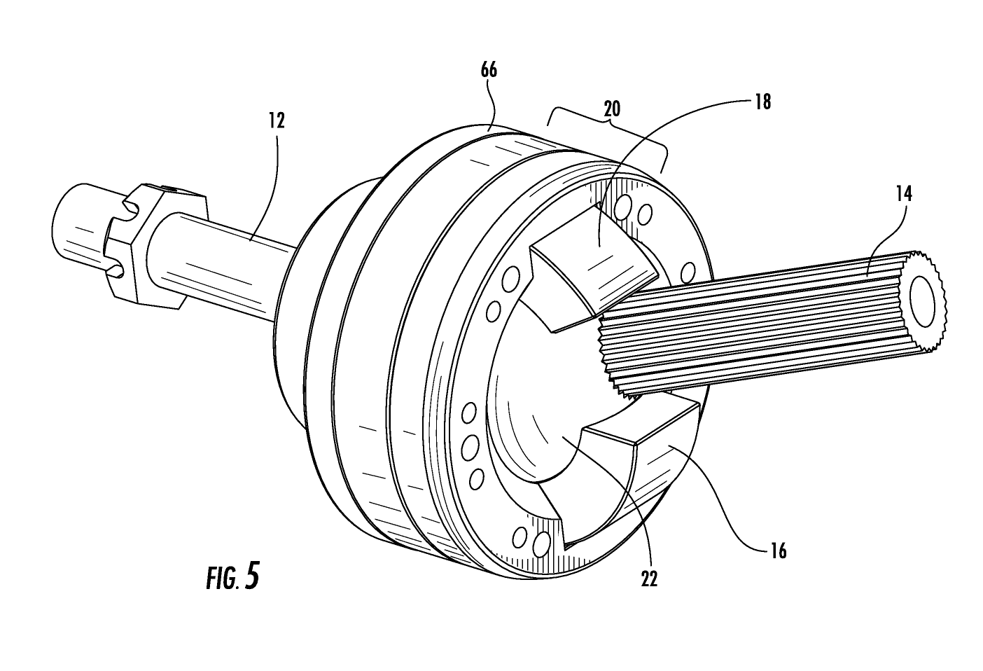

Referring now to FIGS. 2-5, operation of the rotational connector device 10 is shown. The shafts 12, 14 are set to an angle 17. As the shaft 12 rotates as shown by the rotational arrow 72 in FIG. 2, the shaft 12 rotates the housing mount 66. Since the housing mount 66 is secured to the housing 20, rotation of the shaft 12 also consequently rotates the housing 20. Rotational motion is transferred from the housing 20 to the washers 16, 18 which are disposed within the notches 40-46 of the housing. During rotation, the washers 16, 18 slide within the notches 40-46. By comparing FIGS. 2 and 3, the washer 16 moves outward from the housing 20 by a degree, whereas, the washer 18 recedes into the housing 20. Rotational motion is also transferred to the inner spherical member 22 by way of pins 56, 58. The pins 56, 58 are rotationally disposed within recesses 60, 62. The pins 56, 58 are connected to the inner member 22. The inner spherical member 22 transfers rotational motion to the second shaft 14 since the inner spherical member 22 is fixedly attached to the second shaft 14.

Between the washers 16, 18 and the spherical inner member 22, the inner spherical member 22 pivots about pivot axis 54 in relation to the washers 16, 18. Between the housing 20 and the washers 16, 18, the washers 16, 18 rotationally slide within the notches 40-46 formed in the housing 20 about axis 47. Throughout rotational movement of the first shaft 12, (1) the washers 16, 18 may slide within the notches 40-46, and (2) the inner spherical member 22 pivots about the washers 16, 18. This is illustrated by the rotational sequence shown in FIGS. 2-5.

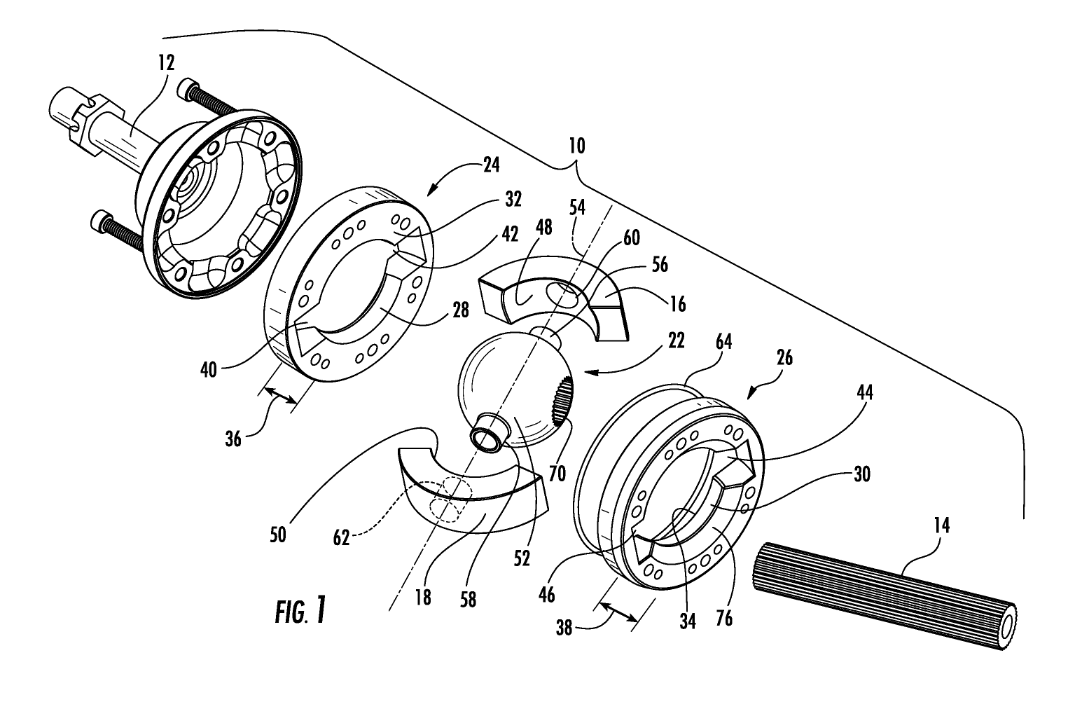

In the embodiment shown in FIGS. 1-5, the rotational connector device 10 has washers 16, 18 that slide within the notches 40-46 of the first and second halves 24, 26 of the housing 20. The washers 16, 18 distribute the load imposed by the pins 56, 58 so as to mitigate stress concentrations that the pins 56, 58 may impose upon the inner surfaces of the notches 40-46. Moreover, the washers 16, 18 allow the first and second shafts 12, 14 to be set at a greater angle 17. However, it is also contemplated that the rotational connector device 10 may also function without the washers 16, 18. During rotational movement of the shafts 12, 14, the pins 56, 58 will slide and rotate on the inner surfaces of the notches 40-46. The angle 17 is limited to the point at which the pins 56, 58 would come out of the notches 40-46. In this regard, the washers 16, 18 allow the first and second shafts 12, 14 to be set at a greater angle yet transmit rotational motion between the first and second shafts.

It is also contemplated that two or more rotational connector devices 10 may be secured to each other in series. A second shaft of a first rotational connector device 10 may be coaxially aligned and attached to a first shaft of a second rotational connector device 10. A second shaft of the second rotational connector device 10 may be coaxially aligned and attached to a first shaft of a third rotational connector device 10. Rotation of the first shaft of the first rotational connector device 10 is operative to rotate a second shaft of the third rotational connector device 10. In this example, three rotational connector devices 10 were connected to each other to transmit rotational motion. Each of the first and second shafts of the rotational connector devices 10 may be at a skewed angle.

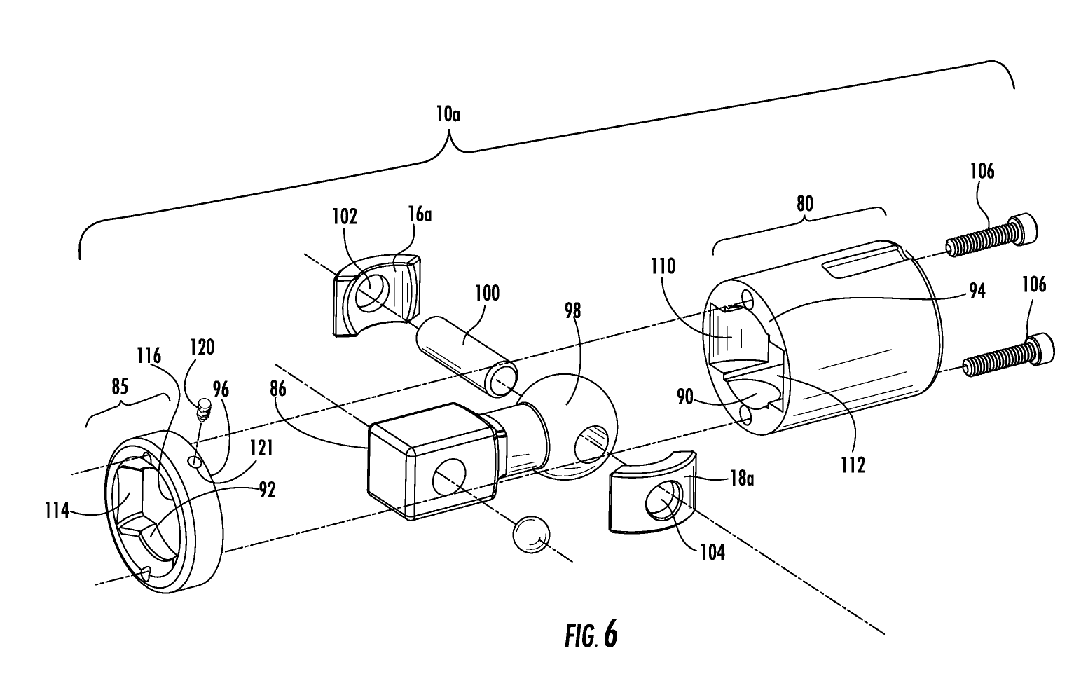

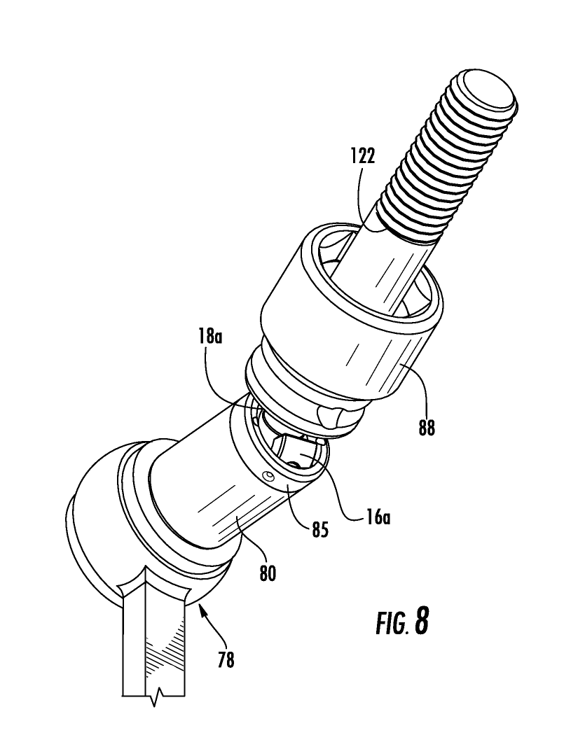

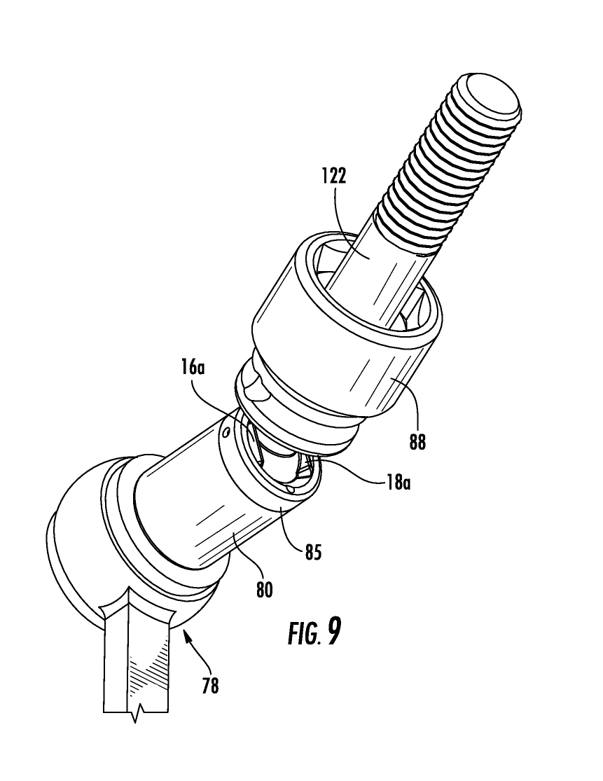

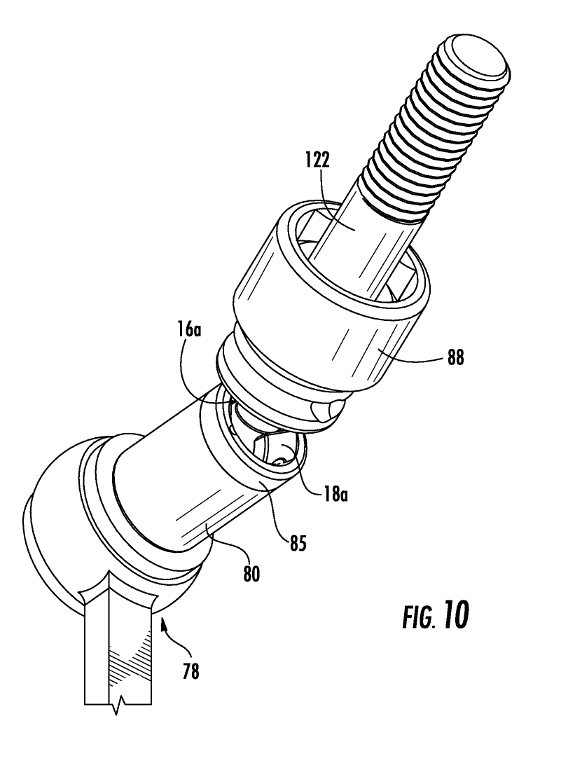

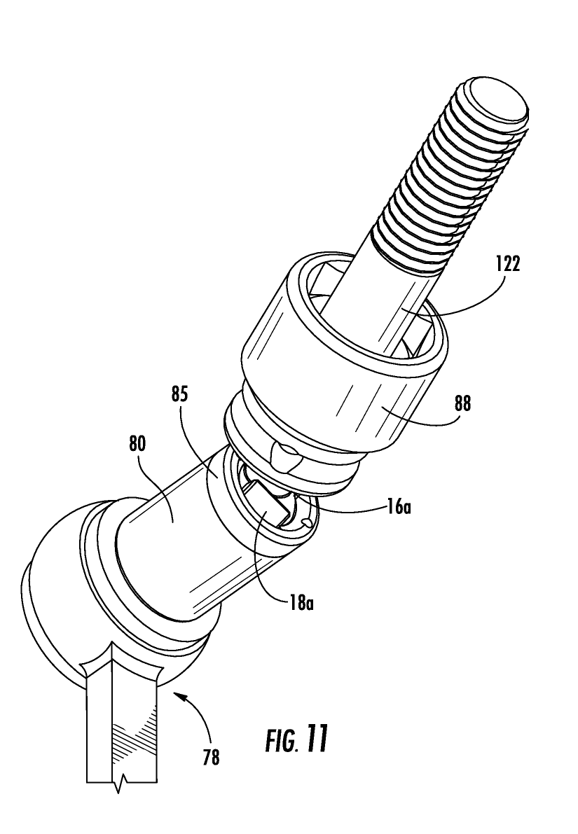

Referring now to FIGS. 6-11, there is depicted another aspect of the present invention wherein the rotational connector device 10a is applied to a socket wrench 78. On one end of the rotational connector device 10a, a first-half 80 of the housing 82 is sized and configured to mount to a socket drive mechanism 84. The socket drive mechanism 84 may have a spring detent that holds the rotational connector device 10 onto the socket wrench 78.

The socket wrench 78 drives the housing 82 and a socket connector 86, which may be removably secured to the socket 88. The rotational connector device 10a allows a mechanic or user to rotate a screw, nut or bolt in a hard-to-reach area even if it is not accessible and does not have a line of sight to the socket wrench 78.

The rotational connector device 10a operates in a similar manner as that described in relation to the rotational connector device 10 as shown in FIGS. 1-5. Along these lines, the rotational connector device 10a has a two-part housing 82 that includes the first-half 80 and a second-half 88. The two halves 80, 85 collectively form at least a portion of a spherical cavity by way of inner surfaces 90, 92. The inner surfaces 90, 92 are joined at the inside surfaces 94, 96 of the first and second halves 80, 85. This junction defines the equator of the spherical cavity defined by the inner surfaces 90, 92. Moreover, the rotational connector device 10a has an inner spherical member 98 which is trapped between the first and second halves 80, 85 within the spherical cavity defined by the inner surfaces 90, 92.

The rotational connector device 10a additionally has washers 16a, 18a that are pinned to the inner member 98 by way of pin 100. The pin 100 extends through the inner spherical member 98 and protrudes out of the outer surfaces from the inner member 98. The washers 16a, 18a each include a through hole or recess 102, 104 which receives pin 100 and allows the washers 16a, 18a to pivot with respect to the inner member 98. The first and second halves 80, 85 of the housing 82 may be held together by way of screws 106.

The first and second halves 80, 85 also have notches 110, 112, 114 and 116 which receive the washers 16a, 18a. The exterior surface of the washers 16a, 18a defines a configuration which is generally complimentary in shape to the interior surfaces of the notches 110, 112, 114, 116. The exterior surfaces of the washers 16a, 18a slide within the notches 110, 112, 114, 116. The interior surfaces of the washers 16a, 18a at least partially define a spherical configuration which mates with the spherical outer surface of the inner member 98.

The rotational connector device 10a may have a set screw 120 to temporarily hold the angle 118 between the first shaft (i.e., socket drive mechanism 84) and the second shaft (i.e., socket connector 86). The distal tip of the set screw 120 may be Teflon coated. The set screw 120 may be threaded into threaded hole 121. The threaded hole 121 is aligned so that the set screw bears down on the exterior surface of the inner member 98. However, it is also contemplated that the threaded hole 121 may be formed in the housing so that the set screw bears down on the exterior surface of either one of the washers 16a, 18a. The user can set the angle between the first and second shafts by holding the socket connector 86 in a relative position to the socket drive mechanism 84 and tightening set screw 120 that bears down on the exterior surface of the inner member 98. The set screw 120 may have a Teflon tip to prevent any marring on the exterior surface of the inner member 98.

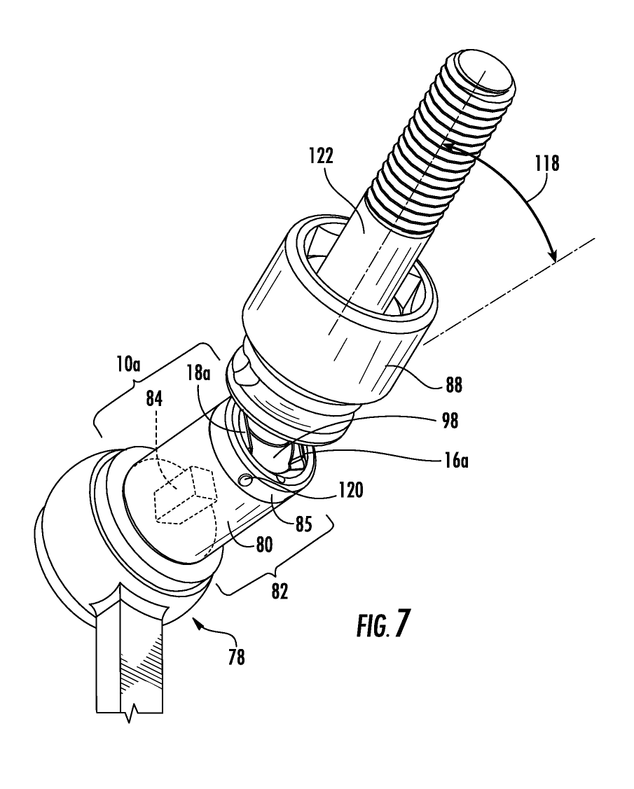

Referring now to FIGS. 7-11, the rotational connector device 10a is shown as it is being rotated to turn a bolt 122. The socket wrench 78 is connected to the first half 80 of the housing 82 of the rotational connector device 10(a). The socket 88 is attached to the socket connector 86 (see FIG. 6). The angle between the bolt 122 and the socket drive mechanism 84 is positioned and set in place by tightening set screw 120 which bears down on the inner member 98. In this manner, the socket wrench 78, rotational connector device 10a, socket 88 and the bolt 122 can be set at a particular angle 118. The user can maneuver the bolt 122 into position by sole use of the handle of the socket wrench 78.

The above description is given by way of example, and not limitation. Given the above disclosure, one skilled in the art could devise variations that are within the scope and spirit of the invention disclosed herein, including various ways of coupling a series of joints together. Further, the various features of the embodiments disclosed herein can be used alone, or in varying combinations with each other and are not intended to be limited to the specific combination described herein. Thus, the scope of the claims is not to be limited by the illustrated embodiments.

1-15. (canceled)

16. A mechanical joint for transferring rotational motion from a first shaft to a second shaft, comprising:
a housing comprised of first and second halves which, together, form a central cavity flanked by first and second slots, the housing first half being securable to the first shaft;
a spherical inner member rotatably seated within the central cavity, the inner member being securable to the second shaft;
first and second drive pins extending in opposed diametrical fashion from the inner member; and
first and second arcuate blocks flanking the inner member, each block having a first end and is second end, a convex outer surface, a concave inner surface, and a recess formed in the inner surface for receiving a drive pin;
wherein the first drive pin is rotatably seated within the recess in the first arcuate block, the second drive pin is rotatably seated within the recess in the second arcuate block, the first arcuate block is slidably seated within the first slot, and the second arcuate block is slidably seated within the second slot.

17. The mechanical joint of claim 16, wherein, when the joint is secured to the first and second shafts, rotation of the first shaft causes the second shaft to rotate with equal rotational speed.

18. The mechanical joint of claim 16, wherein the recess formed in the inner surface of each arcuate block is located at a position substantially equidistant from the first and second ends.

19. The mechanical joint of claim 16, wherein the outer surface of each arcuate block is cylindrically convex.

20. The mechanical joint of claim 16, wherein the inner surface of each arcuate block is spherically concave.

21. The mechanical joint of claim 16, wherein the first and second arcuate blocks together form an integral, C-shaped unit with an opening that accommodates the second shaft.

22. The mechanical joint of claim 16, wherein the housing first half has an inner face, the housing second half has an inner face, and the inner face of the housing first half abuts the inner face of the housing second half.

23. The mechanical joint of claim 16, wherein the housing second half is substantially annular and thereby defines an open interior space with a center.

24. The mechanical joint of claim :43, wherein the housing second half has an inner perimeter with a shape corresponding to a circle diametrically flanked by two alcoves.

25. The mechanical joint of claim 23, wherein the housing second half has an inner face, an outer face, and an inner sidewall, the inner sidewall having first and second sloped sections and first and second concave sections, wherein the sloped sections slope inwardly from the outer face of the housing second half toward the center of the interior space and thereby accommodate lateral movement of the second shaft, and the concave sections closely conform to a portion of the outer surface of the spherical inner member and thereby form a seat therefor, while permitting the inner member to rotate.

26. The mechanical joint of claim 16, wherein the first and second drive pins form a unitary structure with the spherical inner member.

27. The mechanical joint of claim 16, wherein the inner member has a grooved hole that can fixedly receive one end of the second shaft.

28. A mechanical joint for transferring rotational motion from a tool to a socket. Where the tool has a first square fitting and the socket has a recess for receiving a square fitting, the joint comprising:
a housing comprised of first an second halves which, together, form a central cavity flanked by first and second slots, the housing first half having formed at one end thereof a recess for receiving the tool's square fitting;
a spherical inner member rotatably seated within the central cavity, the inner member having a through hole formed therein,
a second square fitting coupled to or integral with the inner member;
a drive pin extending through and protruding from the inner member's through hole; and
first and second arcuate blocks flanking the inner member, each block having a first end and a second end, a convex outer surface, a concave inner surface, and a recess formed in the inner surface for receiving the drive pin;
wherein the drive pin is rotatably seated within the recesses in the first and second arcuate blocks, the first arcuate block is slidably seated within the first slot, and the second arcuate block is slidably seated within the second slot; and
wherein, when the joint is coupled to the tool's square fitting and a socket is coupled to the second square fitting, rotating the first square fitting causes the socket to rotate.

29. The mechanical joint of claim 28, further comprising means for holding the socket at a fixed angular position relative to the first square fitting.

30. The mechanical joint of claim 28, wherein the second square fitting includes a spring-loaded bail therein.
